(19) United States
(12) Patent Application Publication
(10) Pub. No.: US 2007/0295219 A1
(43) Pub. Date: Dec. 27, 2007

(54) Brewed-Beverage Vending Machine Provided With Means for Cleaning the Brewing Filter

(76) Inventors: Jan Cornelius Van Hattem, Amerogen (NL); Robert Francis De Reus, Zanevaar (NL)

Correspondence Address: WENDEROTH, LIND & PONACK, L.L.P., 2033 K STREET N. W., SUITE 800, WASHINGTON, DC, 20006-1021, US

(21) Appl. No.: 11/631,616

(22) PCT Filed: Jun. 27, 2005
(86) PCT No.: PCT/EP05/52995

§ 371 Date: Aug. 3, 2007

(30) Foreign Application Priority Data
Jul. 5, 2004 (IT) PN2004A000048

(51) Int. Cl. A47J 31/60

(52) U.S. Cl. 99/289 R

(57) ABSTRACT

A vending machine (1) comprises a brewing unit (7) provided with a brewing chamber (8) that is closable at the bottom portion thereof by means of a movable filter (9) adapted to retain the brewing residues, and further comprises actuator means (11) adapted to cause said filter (9) to displace from a first brewing position, in which said filter (9) is associated to said brewing chamber (8) in a fluid-tight manner, to a second discharge position, in which said filter (9) is separated from said brewing chamber (8), and vice-versa. The vending machine (1) is characterized in that said actuator means (11) comprise cleaning means (24) interacting with said filter (9) to remove the brewing residues therefrom, said actuator means (24) actuating said cleaning means (24) when the filter (9) is in said second discharge position thereof.

The present invention refers to a vending machine for beverages prepared by brewing, which is provided with means for cleaning the brewing filter.

Vending machines for brewed beverages are provided with a brewing unit, in which there are generally provided a brewing chamber, where water is mixed with the substance to be infused, and a filter collecting the brewing or infusion residues, while allowing the infusion, i.e. the brew to permeate it. A need that is strongly and widely felt in connection with this kind of vending machines is the actual capability of ensuring an adequate degree of cleaning of the various component parts of the brewing unit after each utilization or operation cycle thereof. For instance, when producing certain hot beverages starting from raw materials in powder form, the need arises at the end of each cycle for the brewing or infusion residues to be removed from the brewing unit and, in particular, from the filter in which they collect and build up.

A number of devices that are designed to ensure such cleaning of the brewing filter, i.e. to enable the brewing filter to be cleaned, are known in the art. One such prior-art device for the removal of brewing residues, and adapted to be used in particular on substantially flat filtering surfaces, includes a brush, or a scraper, which is brought into contact with the filtering surface for the latter to be scrubbed therewith.

An application of a device of the above-cited kind is described in the U.S. Pat. No. 4,709,625, which discloses a beverage vending machine that does not make use of any pressurization systems. This machine comprises a moving carriage, on which there is elastically mounted a brewing container, and on which there is also mounted a brush for cleaning the filter. After the beverage has been brewed, the carriage is displaced so as to cause the brewing container to move away from the filter through which the brew is due to percolate, and which remains in a stationary position. Owing to this displacement, the brush is in turn capable of cleaning the surface of the filter by removing the brewing residues therefrom. A solution of this kind, calling for the brewing container to be displaced, has however a major drawback in that, during the initial phase of its displacement, the brewing container rubs and scratches against the filter itself, thereby impairing the integrity thereof in the long run. In fact, the presence of the elastic means, which are used to connect the carriage with the brewing container, practically causes the latter to be kept pressing against the filter in view of preventing brew from leaking and spilling through the filter-container interface. This state of the container tightly fitting against the filter, however, turns out as being disadvantageous when the container is displaced, i.e. moved away from the filter, since it most obviously contributes to keeping a high degree of friction between the surfaces that are due to move relative to each other.

A further application of the above-cited prior-art arrangement is described in the U.S. Pat. No. 5,351,604 that discloses a brewing unit in which the brewing chamber can be moved away from the filter by lifting it off, rather than displacing it through a translational movement, as shown in U.S. Pat. No. 4,709,625. Lifting the brewing chamber, however, is rather complicated and awkward to perform and introduces a number of disadvantageous complications in the design and construction of the vending machine altogether. For instance, the mechanical members used to lift the brewing chamber must be duly strengthened in view of adequately coping with the actual weight of such chamber, while the totality of the various water, liquid and electrical connections must be frequently checked to make sure that they do not undergo any loss of functionality due to the interaction thereof with the moving parts of the arrangement.

Further to cleaning the filter systematically, vending machines used to prepare and dispense brewed beverages further require periodical cleaning of the brewing chamber itself. Now, such cleaning is disadvantageously impeded in the embodiments disclosed and described in the above-cited U.S. Pat. Nos. 4,709,625 and 5,351,604, owing to the necessary provision of the various parts and members required to displace and lift, respectively, said brewing chamber. In particular, the U.S. Pat. No. 4,709,625 shows a way in which the brewing residues are to be removed from the container that is provided to receive and hold the raw materials, and which acts as the actual brewing chamber for preparing the beverage. According to the proposed solution, the container is caused to jolt by having it moving along a correspondingly shaped guide that causes said container to first drop abruptly and then stop in an equally abrupt manner. This solution, however, does by no means turn out as being always effective in reaching its purpose, owing to the rather strong of adhesion that is generally to be found between wet brewing residues and the surfaces of the brewing container.

It therefore is a main object of the present invention to provide a brewed-beverage vending machine that overcomes and does away with such typical drawbacks and disadvantages of prior-art vending machines of this kind, as noted above.

Within this general object, it is a purpose of the present invention to provide a brewed-beverage vending machine, which is effective in simplifying the operations required to clean the various component parts thereof and ensure proper maintenance.

Another purpose yet of the present invention is to provide a brewed-beverage vending machine, which is simple to construct with a limited number of component parts.

According to the present invention, these aims are reached in a brewed-beverage vending machine incorporating the characteristics as recited in the appended claim 1.

Features and advantages of the present invention will anyway be more readily understood from the description that is given below by way of non-limiting example with reference to the accompanying drawings, in which:

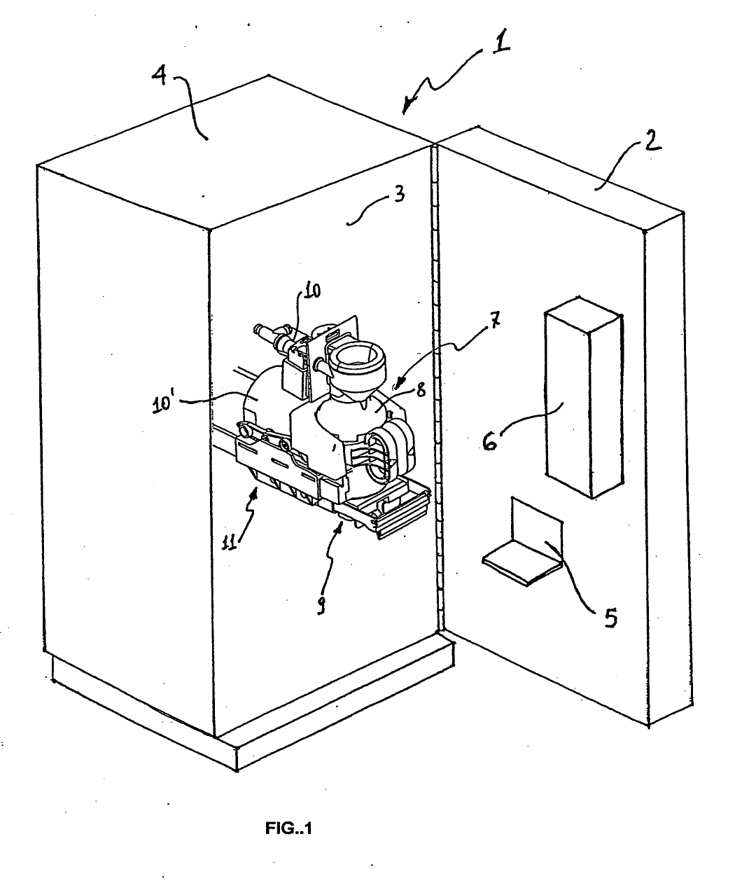

FIG. 1 is a perspective view of a vending machine according to the present invention, within which there is comprised a brewing unit;

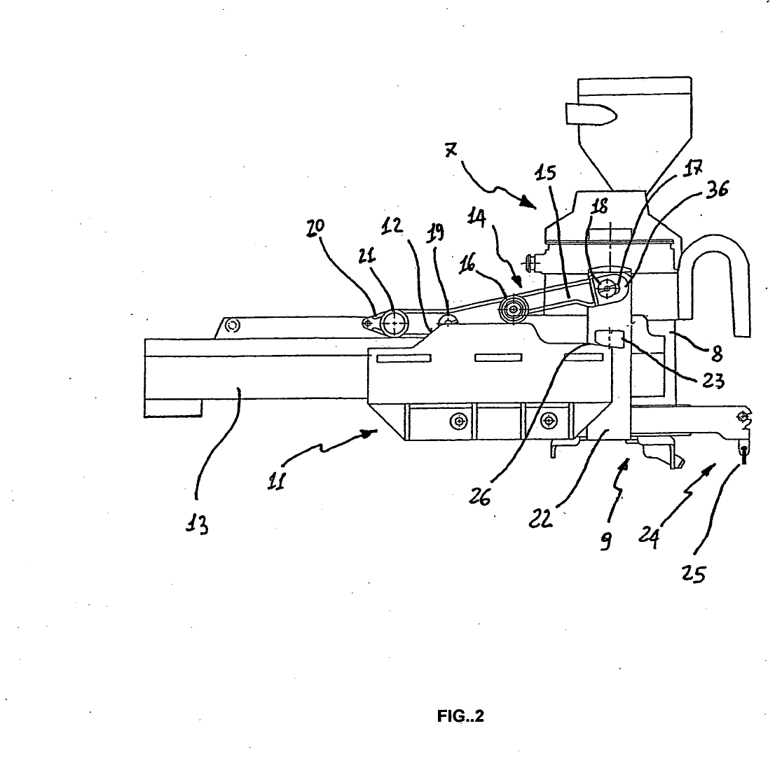

FIG. 2 is a side view of the brewing unit, along with the actuator means for displacing the filter;

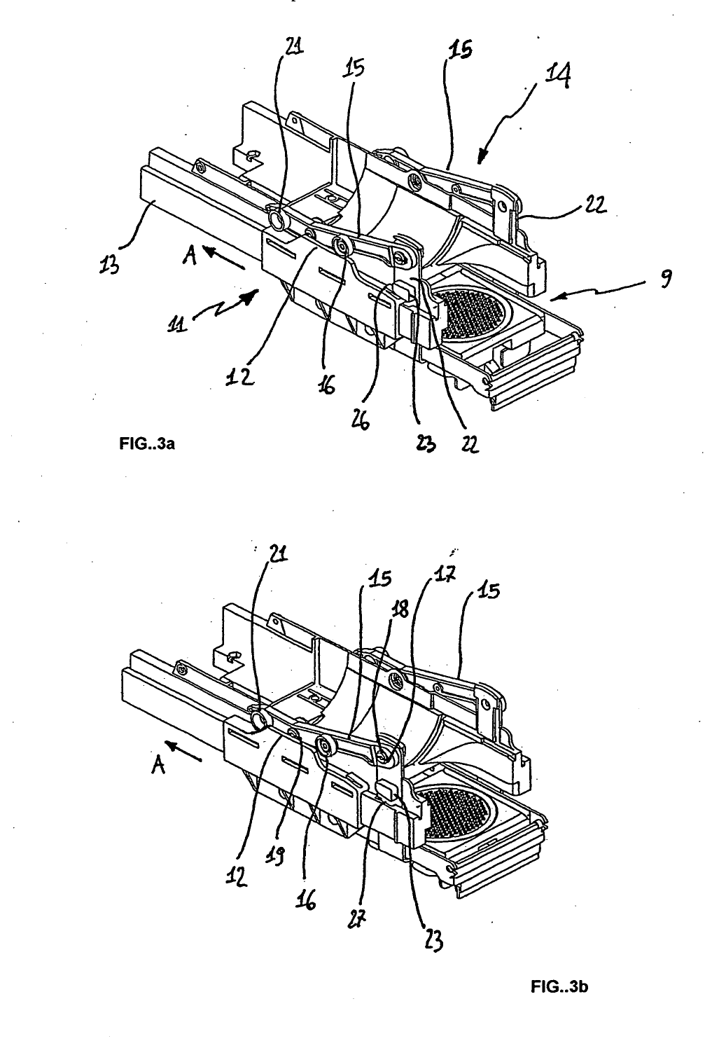

FIG. 3a is a perspective view of the actuator means and the filter in the brewing position;

FIG. 3b is a perspective view of the actuator means and the filter when the latter starts moving, i.e. being displaced;

FIG. 3c is a perspective view of the actuator means and the filter at the moment in which the cleaning means start interacting with the filter;

FIG. 3d is a perspective view of the actuator means and the filter at the moment in which the cleaning means have completed a passage thereof over the filter;

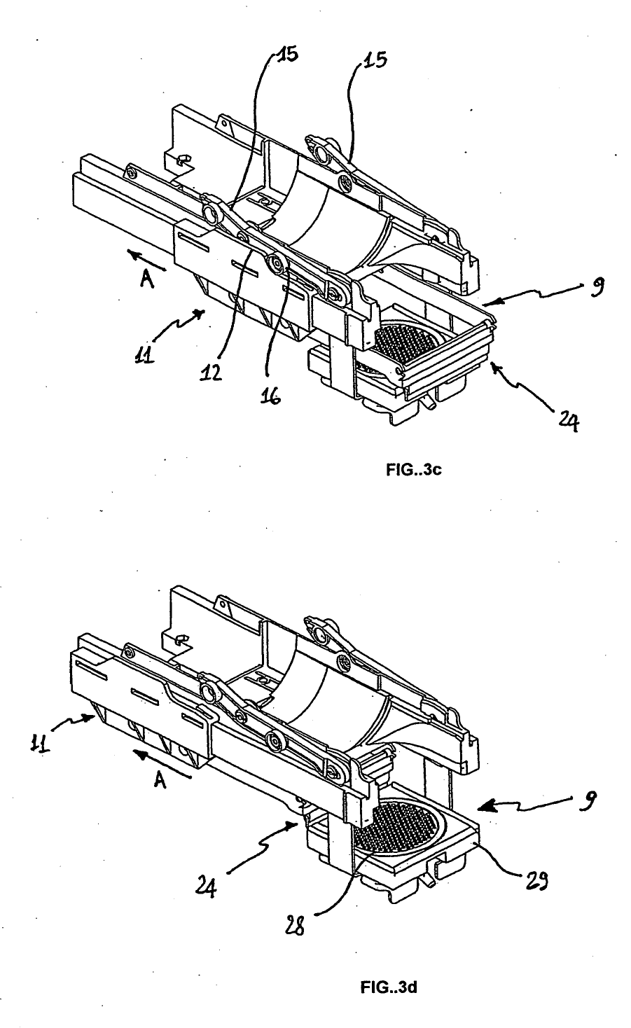

FIG. 4 is a top view of the brewing unit in the phase in which it is being released from the vending machine shown in FIG. 1;

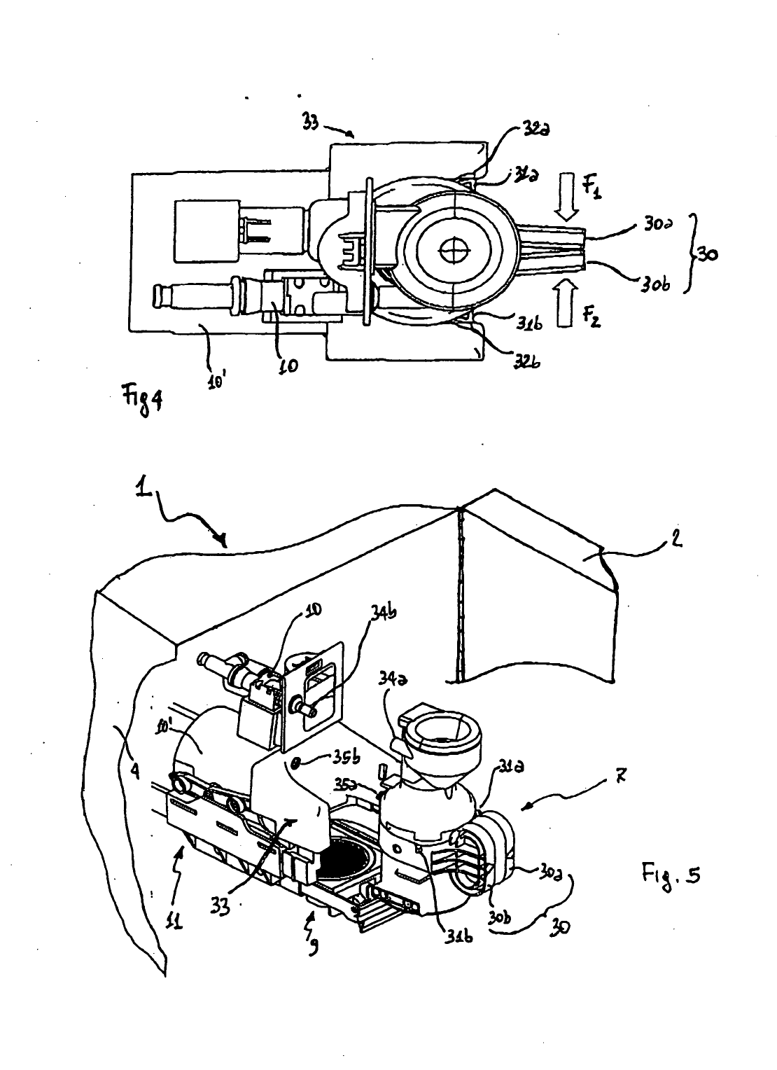

FIG. 5 is a perspective view of the brewing unit, in the state in which it is pulled out of the vending machine shown in FIG. 1.

Schematically shown in FIG. 1 is a vending machine 1 for preparing and dispensing brewed beverages, which is provided with a door 2 that closes a compartment 3 defined by the walls of an outer casing 4. The door 2 is provided with an aperture 5 that allows for the beverage being dispensed by the vending machine 1 to be collected and removed by the buyer. Provided on the door 2 there are also selector means 6 of a kind as substantially known as such in the art, such as a push-button unit, for selecting the beverage that a buyer wishes to drink. The selector means 6 may be integrally provided also with the means for paying the selected beverage, such as for instance a magnetic card reader or a coin-operated mechanism. Inside the compartment 3 there is arranged a brewing unit 7, which is provided with a brewing chamber 8 being closable on the bottom by means of a filter 9 that is movable with the help of actuator means 11 and adapted to retain the brewing residues. The brewing unit 7 is connected with fluid-carrying means 10, 10′, such as for instance water delivery means and means for supplying a compressed gas. It will most readily be appreciated that—although not shown in the Figure—provided inside said compartment 3 there will be also appropriate devices for storing and dispensing cups, as well as one or more containers for storing the raw materials required to prepare the beverages, further of course to the various water and fluid conduits and power-supply means as required by the vending machine 1 to operate.

Shown in FIG. 2 are the brewing unit 7 and the filter 9, the latter in the state in which it is in a first brewing position thereof, i.e. associated in a fluid-tight manner to the bottom of the brewing chamber 8. The same FIG. 2 also illustrates the actuator means 11, which cause the filter 9 to move and displace in the manner that shall be explained in greater detail below.

These actuator means 11 comprise a cam 12 for actuating the filter 9 into moving, and are in a preferred manner slidably associated to a support structure 13 that is attached to the vending machine 1 (not shown in FIG. 2). The actuator means 11 also comprise cleaning means 24, such as for instance a brush 25, which are adapted to interact with the filter 9 to ensure the removal of the brewing residues from the same filter when it is caused to disengage the brewing chamber 8 and moved into a second discharge position. When the filter 9 is in this second position, the cleaning means 24 are operated by the actuator means 11. To this purpose, the cleaning means 24 are preferably attached to the actuator means 11.

The filter 9 is associated to the support structure 13 by means of an articulated kinematical mechanism 14. This kinematical mechanism 14 comprises at least a first lever 15 provided with a roller-type tappet 16 moving on the cam 12. This at least a first lever 15 is pivotally connected to the support structure 13 via the pivoting joint 19, and comprises a first end portion 36 provided with a slot-like aperture 17, in which a pin 18 connected to the filter 9 is able to move. Said first lever 15 further comprises a second end portion 20 provided with an opposing member 21 which, as this shall be explained in greater detail further on, interacts with the cam 12 to remove the filter 9 from the brewing position illustrated in FIG. 2, by rapidly separating it from the bottom of the brewing chamber 8. To this purpose, the pivoting joint 19 connecting the first lever 15 to the support structure 13 is situated between the first end portion 36 and the second end portion 20 of the lever 15, so that the latter is able to behave as a rocker arm.

As illustrated in FIG. 2, the articulated kinematical mechanism 14 comprises at least a second lever 22 associated to the filter 9. Provided on this second lever 22 there is a wedge-shaped jut 23 that interacts with a conjugate surface 26 provided on the actuator means 11 so as to associate the filter 9 with the brewing chamber 8 in a fluid-tight manner. The second lever 22 is pivotally associated to the first lever 15 via the pin 18.

FIGS. 3a, 3b, 3c and 3d illustrate the way in which the actuator means 11 work in view of causing the filter 9 to displace between a first brewing position, in which it is associated to the brewing chamber 8, and a second discharge position, in which it is separated and moved away from the brewing chamber 8, wherein the brewing chamber 8 is not shown in these Figures for reasons of greater clarity.

In these FIGS. 3a, 3b, 3c and 3d the articulated kinematical mechanism 14 is shown to feature a symmetrical structure constituted by a pair of first and second levers 15, 22. The movements of this articulated kinematical mechanism 14 shall now be described with reference to the levers that appear in the same Figures, these movements being on the other hand similar to the ones of the levers that do not appear completely in said Figures.

In FIG. 3a, the filter 9 is located in the first brewing position thereof and the roller-type tappet 16 of each first lever 15 is engaging the respective cam 12. The wedge-shaped juts 23 of each second lever 22 are engaging the respective conjugate surfaces 26, so as to exert a force urging the filter against the bottom wall of the brewing chamber 8, thereby ensuring a fluid-tight fitting of said filter thereagainst. After a beverage has been brewed and the resulting brewing residues have settled on the filter 9, the actuator means 11 are driven by motor means (not shown) to move in the direction indicated by the arrow A in which the filter 9 is moved away from the brewing chamber 8. In this way, the roller-type tappet 15 rotates about its own axis by following the profile of the cam 12 sliding on the support structure 13. Due to this movement of the actuator means 11, the wedge-shaped jut 23 is caused to disengage the respective conjugate surface 26, thereby allowing the filter 9 to move downwards owing to the force of gravity.

In order to facilitate separation of the filter 9 from the bottom of the brewing chamber 8, which is not shown in the Figure for reasons of greater simplicity, there may be provided an opposing member 21, with which the cam 12 comes into contact to generate on each first lever 15 a torque of such intensity as to cause each such lever to rotate about the pivoting joint 19 by overcoming the force of adhesion between the filter 9 and the bottom of the brewing chamber 8 that may possibly be brought about by the brewing process. The interaction of said opposing member 21 and the cam 12 is represented in FIG. 3b.

As the filter 9 is in this way caused to move away from the brewing chamber 8, the wedge-shaped jut 23 does not interfere with the support structure 13 thanks to the provision of a groove 27 in which the same jut 23 is able to move.

In FIG. 3c, the filter 9 has completed the movement to travel away from the brewing chamber 8 and lies in its discharge position. At this point, while the actuator means 11 keep moving on in the direction indicated by the arrow A, the cleaning means 24 start to interact with the filter 9 to remove the brewing residues therefrom. Each lever 15 keeps motionless and the roller-type tappet 16 rotates on the moving cam 12. The cleaning means 24 perform a passage over the entire surface of the filter 9, as best illustrated in FIG. 3d. Upon completion of such passage on the filter surface by the cleaning means 24, the motor means that drive the actuator means 11 are stopped and set to reverse the direction of movement, in such a manner as to enable the movements illustrated in FIGS. 3a, 3b, 3c and 3d to be repeated in the reverse order, i.e. the cleaning means 24 to pass again over the filter 9, thereby completing the cleaning of the same filter while it is at the same time returned into the brewing position thereof.

Also illustrated in FIG. 3d is the possibility for the filter 9 to be constituted by a perforated surface 28 that is removably associated to a receptacle 29. If desired, the perforated surface 28 and the receptacle 29 may be made integral with each other as a single-piece construction.

In view of promoting and facilitating cleaning of the entire brewing unit 7, it may be contemplated that such unit be removably associated to the beverage vending machine by means of quick-release/fitting means 31a, 31b, as this is best shown in FIGS. 4 and 5. To this purpose, the brewing unit 7 is provided with a handle 30, by which it can be conveniently gripped for removal from the vending machine 1; it further comprises one or more quick-release/fitting water or fluid connections 34a and 35a that fit on the respective sockets 34b and 35b provided on the bearing structure 33. These water or fluid connections 34a and 35a enable a fluid communication to be established between the brewing unit 7 and the fluid-carrying means 10, 10′.

FIG. 4 illustrates the way in which the brewing unit 7 is released from the vending machine 1. When the pair of handgrips 30a and 30b forming the handle 30 is seized, the same handgrips move from a first position, in which the distance between them is the largest one, and in which the brewing unit 7 is regularly fitted in and connected to the vending machine 1, to a second position in which the distance between the handgrips 30a and 30b is at a minimum and the brewing unit is released from the vending machine. Moving the handgrips 30a and 30b in the directions shown by the arrows F₁ and F₂ in FIG. 5 activates the quick-fitting/release means 31a and 31b by causing them to disengage the respective portions 32a and 32b of the bearing structure 33, thereby enabling the brewing unit 7 to be pulled out of the vending machine 1 when seizing the handle 30. Preferably, the quick-fitting/release means 31a and 31b comprise a kind of bayonet joint moving against the action of an elastic member. It will anyway be readily appreciated that a number of other quick-fitting/release means of any type known as such in the art may be used to such purpose in accordance with the present invention. Upon removal from the vending machine, the brewing unit 7 may be held and supported by the handle 30.

Illustrated in FIG. 5 is the brewing unit 7 upon removal thereof from the vending machine 1. In this condition, the water connection 34a or 35a used to convey the water into the brewing unit 7 is tightly sealed to prevent fluid from leaking out of the brewing chamber and spilling inside the vending machine 1, thereby soiling it. This water connection is sealed in a fluid-tight manner automatically as soon as the brewing unit 7 is released from the vending machine 1 for removal.

As it can be readily appreciated from the above disclosure, the present invention fully reaches the aims and advantages as set forth hereinbefore by providing a brewed-beverage vending machine in which the filter due to retain the brewing residues and the brewing unit can be most easily and conveniently cleaned. In addition, the possibility for the brewing unit to be removed from, i.e. pulled out of the vending machine, along with the possibility for such unit to be replaced, enables the same to most rapidly undergo maintenance, while avoiding disadvantageous machine down-times. Moreover, the vending machine itself features a simple, cost-effective construction.

It will be readily appreciated that the materials used for the various component parts of the inventive arrangement, as well as the shapes and the sizing thereof, may of course be each time so selected as to more appropriately fit the particular applications and requirements. In addition, the various parts forming the object of the present invention shall not necessarily be understood as being limited to the particular embodiments described and illustrated above, but can rather be the subject of a number of other, different embodiments or modifications thereof without departing from the scope of the present invention.

1-19. (canceled)

20. Brewed-beverage vending machine (1) comprising:
a brewing unit (7) provided with a brewing chamber (8) that is closable at the bottom portion thereof by means of a movable filter (9), said filter (9) being adapted to retain the brewing residues;
actuator means (11) adapted to cause said filter (9) to displace from a first brewing position, in which said filter (9) is associated to said brewing chamber (8) in a fluid-tight manner, to a second discharge position, in which said filter (9) is separated from said brewing chamber (8), and vice-versa,
said actuator means (11) comprising a cam (12) for actuating the filter (9) into displacing, the actuator means (11) further comprising cleaning means (24) interacting with said filter (9) to remove the brewing residues therefrom, said actuator means (24) actuating said cleaning means (24) when the filter (9) is in said second discharge position thereof, said filter (9) being associated to a support structure (13) by means of an articulated kinematical mechanism (14) comprising at least a first lever (15) provided with a roller type tappet (16) moving on said cam (12)
characterized in that said first lever (15) is pivotally connected to said support structure (13) by means of a pivoting connection (19) situated between a first end portion (36) and a second end portion (20) of the first lever (15).

21. Brewed-beverage vending machine (1) according to claim 20, characterized in that said actuator means (11) are slidably associated to said support structure (13).

22. Brewed-beverage vending machine (1) according to claim 20, characterized in that said cleaning means (24) are attached to said actuator means (11).

23. Brewed-beverage vending machine (1) according to claim 20, characterized in that said cleaning means (24) are comprised of a brush (25).

24. Brewed-beverage vending machine (1) according to claim 20, characterized in that said first end portion (36) is provided with a slot-like aperture (17) in which a pin (18) connected to said filter (9) is able to move.

25. Brewed-beverage vending machine (1) according to claim 20, characterized in that said second end portion (20) is provided with an opposing member (21) that interacts with said cam (12) to move said filter (9) away from said first brewing position thereof.

26. Brewed-beverage vending machine (1) according to claim 20, characterized in that said articulated kinematical mechanism (14) comprises at least a second lever (22) associated to said filter (9).

27. Brewed-beverage vending machine (1) according to claim 26, characterized in that said second lever (22) comprises a wedge-shaped jut (23) that interacts with a conjugate surface (26) provided on said actuator means (11) to associate said filter (9) to said brewing chamber (8) in a fluid-tight manner.

28. Brewed-beverage vending machine (1) according to claim 20, characterized in that said filter (9) is constituted by a perforated surface (28) that is removably received in a receptacle (29).

29. Brewed-beverage vending machine (1) according to claim 28, characterized in that said perforated surface (28) and said receptacle (29) are made integral with each other in a single-piece construction.

30. Brewed-beverage vending machine (1) according to claim 20, characterized in that said brewing unit (7) is removably associated to said vending machine (1) by means of quick-fitting/release connecting means (31a, 31b).

31. Brewed-beverage vending machine (1) according to claim 30, characterized in that said brewing unit (7) comprises one or more quick-release/fitting water or fluid connections (34a, 35a).

32. Brewed-beverage vending machine (1) according to claim 30, characterized in that said brewing unit (7) comprises a handle (30).

33. Brewed-beverage vending machine (1) according to claim 32, characterized in that said handle (3) actuates said quick-fitting/release connecting means (31a, 31b) into releasing.

34. Brewed-beverage vending machine (1) according to claim 32, characterized in that said handle (30) is constituted by a pair of handgrips (30a, 30b) provided in a side-by-side arrangement and adapted to move between a first position, in which they are wide apart from each other and said brewing unit (7) is fitted on to said vending machine (1), and a second position in which they are brought close to each other and said brewing unit (7) is released from said vending machine (1).
